(19) United States
(12) Patent Application Publication
(10) Pub. No.: US 2006/0213107 A1
(43) Pub. Date: Sep. 28, 2006

(54) Retrieval aid

(76) Inventor: John Szymanski, Western Australia (AU)

Correspondence Address: STURM & FIX LLP, 206 SIXTH AVENUE, SUITE 1213, DES MOINES, IA, 50309-4076, US

(21) Appl. No.: 10/595,404

(22) PCT Filed: Oct. 13, 2004
(86) PCT No.: PCT/AU04/01393

§ 371 Date: Apr. 14, 2006

(30) Foreign Application Priority Data
Oct. 15, 2003 (AU) 2003905645
Feb. 23, 2004 (AU) 2004900883
Jun. 22, 2004 (AU) 2004903404

(51) Int. Cl. A01K 97/24

(52) U.S. Cl. 43/17.2

(57) ABSTRACT

A retrieval aid intended for use with a flexible line having an object located at the end of the line, the retrieval aid comprising a shaft (11) having a line engagement member (13) mounted at one end, said engagement member being readily engagable with the line whereby when engaged with the line the engagement member surrounds the line and is capable of movement along the line wherein the engagement member is formed as a coil comprising more than one turn but less than two turns and wherein the plane of the engagement member is inclined to the central axis of the shaft and extends outwardly from the end of the shaft.

### FIELD OF THE INVENTION

This invention relates to a retrieval aid.

### BACKGROUND ART

The invention is intended to be used with a line having an object at the end whereby the aid can be utilised to retrieve the object in the event that the object becomes engaged at a position at which it cannot be readily accessed. An example of an application of the invention relates to retrieval aid which can be utilised in association with a fishing line in order to retrieve a fish hook or lure that may have become snagged. Another application of the aid relates to a means which can be utilised to engage and retrieve a fishing hook that may have become embedded in the body or skin of an animal such as a fish, bird or the like. Another example of an application of the embodiment relates to a device which could be utilised in association with a kite in order to retrieve the kite from a raised structure such as a tree, roof or the like without the necessity to climb the tree or roof to retrieve the device.

A form of fish hook remover which has been proposed in the past is disclosed in U.S. Des. Pat. No. 382,628. In that arrangement a loop is supported at the free end of the shaft to be substantially in line with the shaft. As a result of the configuration of the device and in particular the orientation of the loop to the shaft on the open part of the loop being presented to the fish there is then possibility of the open part catching on parts of the fish (i.e., lip, gill rakers). In addition on the loop engaging a hook in the body of the fish the hook will slide to innermost side of the loop when the device is pushed into the fish to dislodge hook. This results in larger distance between outermost side of the loop and the hook and the possibility of the remover having to be pushed further into the flesh of the fish to dislodge the hook. In addition of the device does not appear to be intended to be used as a lure retriever in order to retrieve a snagged lure and therefore to readily enable engagement with a line to cooperate with the line and permit free movement along the line to a snagged lure.

Another form of retrieval device which has been proposed in the past is disclosed in U.S. Pat. No. 3,374,570. This is directed to a fish hook disgorger and as such is not intended to be used as a lure retriever in order to retrieve a snagged lure and therefore to readily enable engagement with a line to cooperate with the line and permit free movement along the line to a snagged lure.

Another form of retrieval device which has been proposed in the past is disclosed in U.S. Pat. No. 237,916 which utilises a pair of spaced coils. The use of the device requires a line engagement which is complicated. In addition to maintain the line secure on the device requires that it remains in engagement with both coils. Furthermore it depends on gravity to dislodge hook or lure.

Another form of fish hook remover which has been proposed in the past is disclosed in U.S. Pat. No. 66,138,401. This also is not intended to be used as a lure retriever in order to retrieve a snagged lure and therefore to readily enable engagement with a line to cooperate with the line and permit free movement along the line to a snagged lure.

Another form of retrieval which has been proposed in the past is disclosed in U.S. Pat. No. 6,694,664. This device is a bulky item and its configuration requires close attention when engaging the device with a line and a careful monitoring of its position relative to the line which and bearing in mind the use of such devices is usually in a difficult environment the application of such care and attention only serves to add to the difficulties being faced by the user

The discussion throughout this specification, of the background and prior art to the invention is intended only to facilitate an understanding of the present invention. It should be appreciated that the discussion is not an acknowledgement or admission that any of the material referred to was part of the common general knowledge in Australia r any where in the world as at the priority date of the application.

### DISCLOSURE OF THE INVENTION

According to one aspect the invention resides in a retrieval aid intended for use with a flexible line having an object located at the end of the line, the retrieval aid comprising a shaft having a line engagement member mounted at one end, said engagement member being readily engagable with the line whereby when engaged with the line the engagement member surrounds the line and is capable of movement along the line wherein the engagement member is formed as a coil comprising more than one turn but less than two turns and wherein the plane of the engagement member is inclined to the central axis of the shaft and extends outwardly from the end of the shaft.

According to another aspect the invention resides in a retrieval aid intended for use with a flexible line having an object located at the end of the line, the retrieval aid comprising a shaft having a line engagement member mounted at one end, said engagement member being readily engagable with the line whereby when engaged with the line the engagement member surrounds the line and is capable of movement along the line wherein the engagement member is formed as a coil comprising more than one turn but less than two turns which is arcuate through out its extent with the turns overlying each other with one end being fixed to the shaft and the other end being the free end, the portion of the coil; proximate the free end extending outwardly from the perimeter of the underlying turn and wherein the plane of the engagement member is inclined to the central axis of the shaft and extends outwardly from the end of the shaft.

According to a preferred feature of the invention the engagement member is supported from the one end of the shaft to extend to one side of the shaft.

According to a preferred feature of the invention the adjacent portions of the turns of the coil are spaced from each other.

According to a preferred feature of the invention the coil comprises a approximately 1¼ turns.

According to a preferred feature of the invention the base of the coil to which the shaft is attached is axially outermost relative to the shaft and the remainder of the coil. According to an alternative preferred feature of the invention the base of the coil to which the shaft is attached is axially innermost relative to the shaft and the remainder of the coil.

According to a preferred feature of the invention the shaft is extendable. According to a preferred feature of the invention the shaft comprises a plurality of lengths which can be interconnected into an end to end relationship. According to a preferred feature of the invention each end of each length is provided with a threaded fitting which can be threadably engaged with a complementary fitting of another length to enable said ends to end interconnection.

According to a preferred feature of the invention the shaft is resiliently flexible. According to a preferred feature of the invention the shaft is formed of a fibre reinforced plastics material.

According to a preferred feature of the invention the shaft supports a retention member which is slidable along the shaft and a cord is fixed at one end to the retention member, the shaft being formed to prevent disengagement of the retention member from either end of the shaft.

According to a preferred feature of the invention said coil has an internal diameter less than the width of object supported by the line. According to an alternative preferred feature of the invention said coil has an internal diameter greater than the width of object supported by the line.

According to a preferred feature of the invention the line comprises a fishing line and the object comprises a fish hook and/or lure.

According to a preferred feature of the invention the device can be used to retrieve a fish hook from the body of a fish.

According to a preferred feature of the invention the shaft supports at least one stand-off coil intermediate the length of the shaft, said stand-off coil comprises more than one turn wherein the central axis of the coils is substantially parallel to the shaft. According to a preferred feature of the invention the stand-off coil is removably supported from the shaft. According to a preferred feature of the invention the stand-off coils is adapted to be clampingly received between the ends of a pair of interconnected lengths.

According to a preferred feature of the invention the plane of the coil is at an obtuse angle to the shaft of between 100 and 150 degrees.

According to a preferred feature of the invention the coil has a length greater than one revolution and the free end of the coil extends outwardly from the outer perimeter of the coil. According to one embodiment the central axis of the free end subtends an angle of less than 90° to the central axis of the shaft.

The invention will be more fully understood in the light of the following description of several specific embodiments.

### BRIEF DESCRIPTION OF THE DRAWINGS

The description is made with reference to the accompanying drawings of which:

FIG. 1 is a schematic illustration of a retrieval aid according to the first embodiment;

FIG. 2 is a side elevation of the line engagement member according to the first embodiment;

FIG. 3 is an opposite side elevation to that of FIG. 2;

FIGS. 4a and 4b are sectional elevations of couplings according to the first embodiment;

FIG. 5 is a plan view of the line engagement member according to the first embodiment.

FIG. 6 is a plan view of the line engagement member according to the third embodiment;

FIG. 7 is an inverted plan view of the line engagement member according to the third embodiment;

FIG. 8 is a side elevation of the line engagement member according to the third embodiment;

FIG. 9 is an opposite side elevation to that of FIG. 8;

FIG. 10 is a view of the third embodiment illustrating the initial engagement of a fish hook with the retrieval device; and

FIG. 11 is a view of the third embodiment illustrating the engagement of a fish hook with the retrieval device once the fish hook has been freed;

FIGS. 12, 13, 14 and 15 are an isometric view, plan, and opposite side elevations respectively of the fourth embodiment of the invention;

FIGS. 16, 17, 18 and 19 are an isometric view, plan, and opposite side elevations respectively of the fifth embodiment of the invention;

FIG. 20 is an illustration of the coil according to the fifth embodiment illustrating the disengagement of a like attached to a freed floating lure; and

FIG. 21 is an isometric view of a “standoff coil” according to the sixth embodiment of the invention

### DETAILED DESCRIPTION OF SPECIFIC EMBODIMENTS

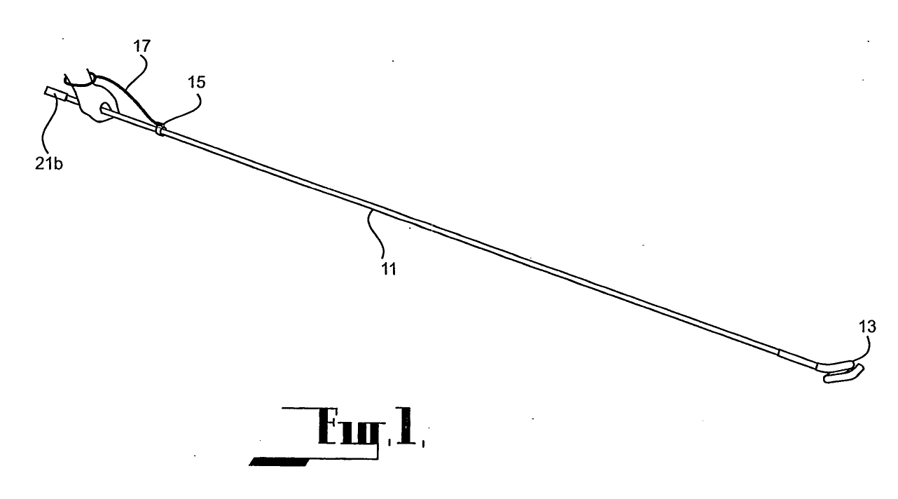

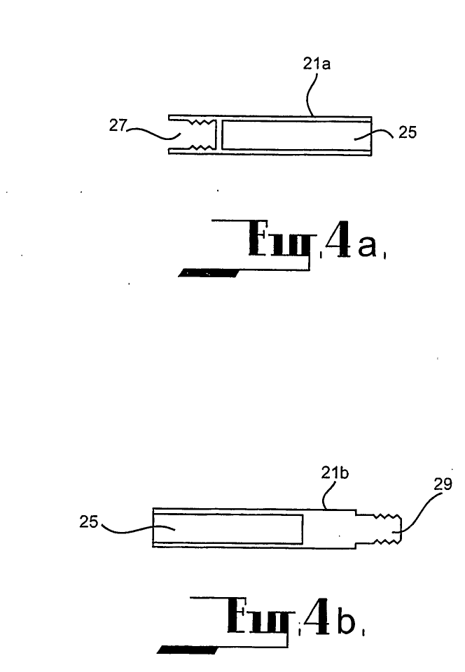

The first embodiment is directed to a retrieval aid which is intended to be used by fishermen in order to facilitate the retrieval of a snagged lure. The embodiment will be described with reference to the FIGS. 1 to 5 of the accompanying drawings which should be appreciated are illustrative only.

The retrieval aid according to the first embodiment comprises a shaft 11, a line engagement member 13 at one end of the shaft 11, a retention member 15 which is slidably supported along the shaft 11 and a cord or lanyard 17 which is connected to the retention member 15.

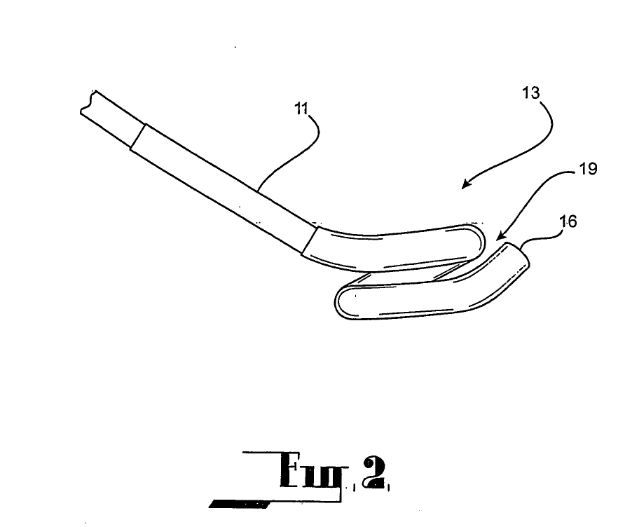

The line engagement member 13 which is shown in FIG. 1 in an enlarged form relative to the shaft comprises a coil member having approximately 1½ turns with the turns in a closely spaced relationship (as shown) where the base of the coil which is innermost relative to the remainder of the coil, is mounted to one end of the shaft 11. The other end of the coil is divergent outwardly from the remainder of the coil and as a result the free end 16 of the coil is offset from the main body of the coil in that it extends axially and generally tangentially outwardly from the main body as is shown at FIGS. 2, 3 and 5. This serves to in use prevent the line, once engaged with the coil from being unintentionally engaged between the turns of the coil and consequently disengaging from the coil.

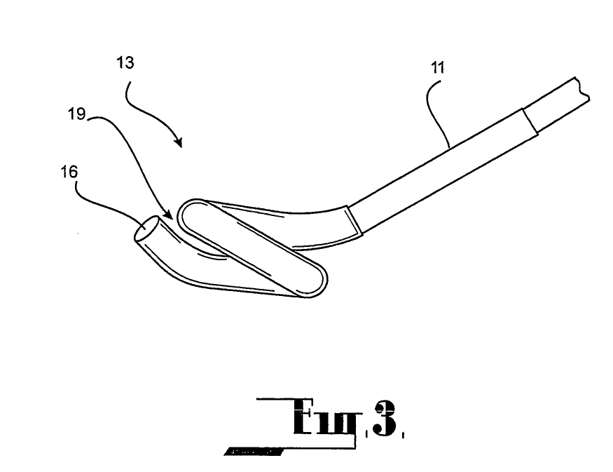

The shaft 11 is formed of a number of lengths of a suitable flexible material such as a solid thin fibre glass rod or other like fibre reinforced plastics which is flexible throughout its length. The lengths are interconnected by a pair of stainless steel coupling members 21a and 21b which are shown at FIGS. 4a and 4b respectively. The coupling members are each formed with a first socket 25 at one end which receives the end of the shaft and is retained on the rod using a suitable adhesive. To facilitate adhesion of the coupling members to the free ends of the shaft the inner face of the first socket 25 of the coupling members 21 is formed with a shallow thread (not shown). The shallow thread assists the bonding of the coupling member to the shaft by the adhesive. It should be appreciated however that the coupling members can be affixed to the shaft by any suitable means. The other end of each coupling member 21a and 21b is formed with a complementary threaded portion where the first coupling member 21a has internally threaded second socket 27 and the second coupling member 21b has an externally screw threaded portion 29 which is threadably engagable with the second socket 27 of the one coupling member 21a.

Each length of shaft (with the exception of the length of shaft which is to support line engagement member) has a first coupling 21a at one end and a second coupling member 21b at the other end. The shaft can comprise one or more length added to it in order to facilitate the extension of the shaft as required by the user. In the case of the length of shaft which is to accommodate the line engagement member both ends have a first coupling member attached to each end and the length of shaft supports line engagement member 13 at its other end. In this regard the inner end of the coil is formed with an external thread which is engagable with the threaded second socket 27 of the first coupling 21a at the, other end of the shaft.

If desired a handle can mounted to the first coupling member 21a which is at the free one end of the shaft or set of interconnected lengths of shaft.

The retrieval aid is intended to facilitate the retrieval of a fishing lure in the event that it becomes snagged. In such an event the line engagement member 13 is engaged with the line by introducing the line into the entry 19 which is located proximate the junction between the line engagement member 13 and the shaft 11 and then between the turns of the engagement member 13 to cause the line to become received within the confines of the coil. Once the engagement member is engaged with the line it can be moved along the length of the line whilst the shaft is being held by the user until such time as the coil reaches the lure at the free end of the line. Once the engagement member is engaged with the lure, the shaft can then be manipulated to cause the coil to engage the lure and effect its disengagement from the snag by pushing the lure away form the snag or like obstruction or pulling the lure from the snag or like obstruction without placing any undue stress on the line itself and the junction between the lure and the line which could result in a loss of the lure.

The line retention member 15 comprises a resilient part circular element which can be resiliently. deformed to be applied over the shaft and which has a diameter less than that of the coupling member or the handle (if present) at the free end of the shaft or set of interconnected set of lengths of shaft in order to prevent its inadvertent disengagement from the shaft. The retention member 15 is slidably received on the shaft 11 and is associated with the lanyard. In use the lanyard can be wrapped around the wrist of the user as shown or can be applied around an adjacent fixed element (such as cleat on a boat) to ensure that the retrieval aid is not lost if it falls from the grasp of the user.

The second embodiment of the invention (not shown) is a variation from the first embodiment and comprises a device which can be used to extract a fish hook from the mouth or body of a fish once caught where the device has a shortened shaft compared to the shaft of the first embodiment and the engagement member takes the same form as in the case of the first embodiment. If desired the second embodiment may be capable of being mounted to the end of a resilient shaft of the form of the first embodiment in order that it can be used to retrieve lures in a similar manner to the first embodiment.

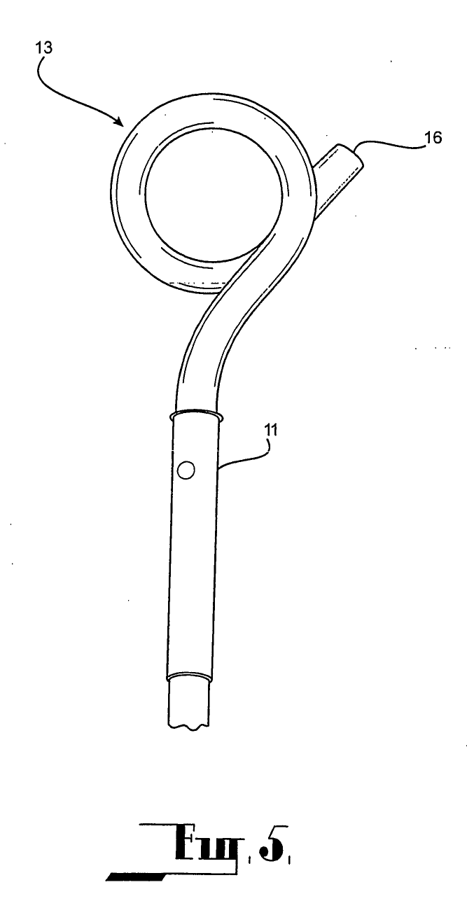

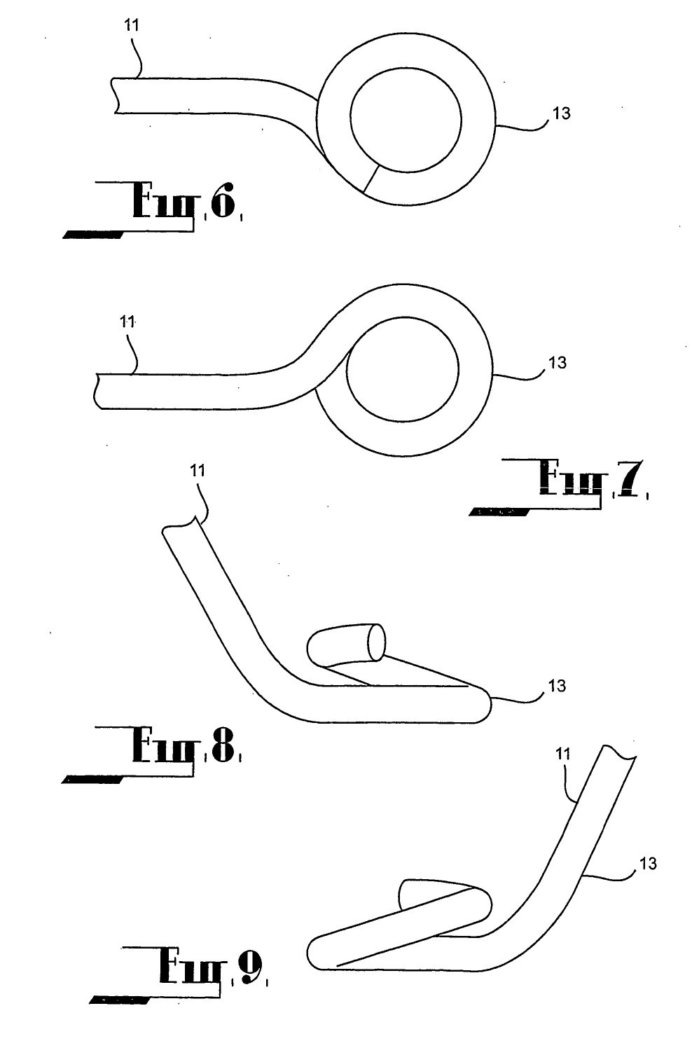

The third embodiment is directed to a retrieval aid which is intended to be used by fishermen in order to facilitate the retrieval of a hook from the mouth of a fish. The embodiment will be described with reference to the FIGS. 6 to 11 of the accompanying drawings which should be appreciated are illustrative only.

The third embodiment is of a similar form to the first embodiment with the exception of the orientation of the coil. In the case of the third embodiment the base of the coil which is attached to the shaft is axially outermost and the turns of the coil are spaced from each other (as shown).

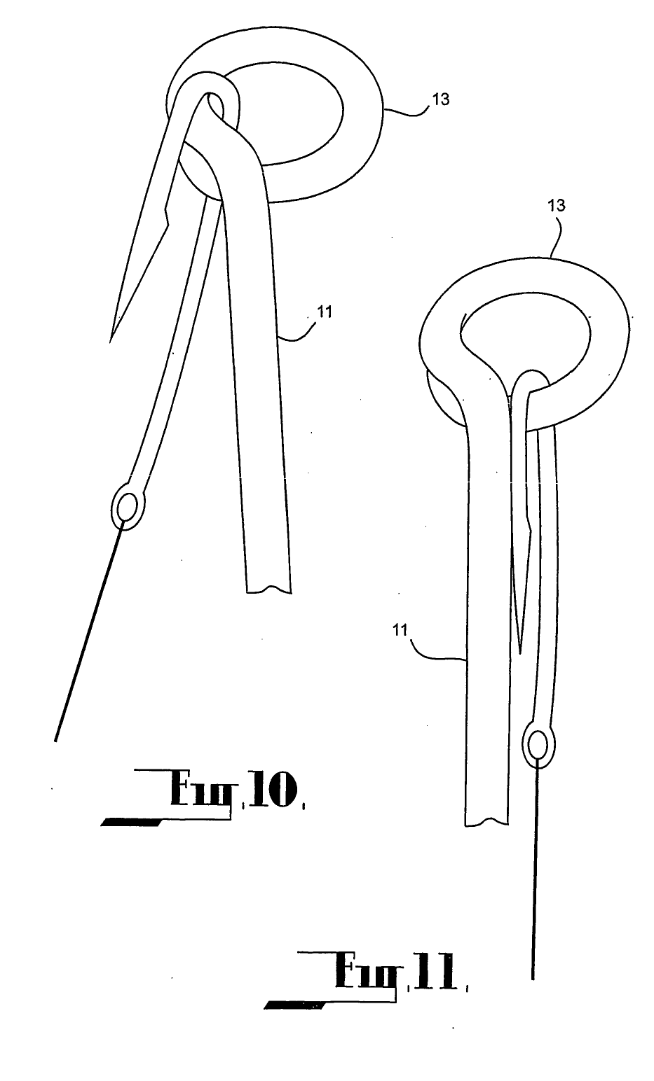

The configuration of the coil of the third embodiment and its orientation enables a line to be readily engaged with the coil by one action. In addition as illustrated at FIGS. 10 and 11 once a hook or lure is engaged by the coil and is disengaged from within the snag or fish the application of tension to the line by the user will cause the hook to slide to the axially innermost position on the coil adjacent the end of the shaft with the point of the hook lying adjacent the shaft. As a result the point of the hook is held alongside the shaft and as a result is less likely to become reengaged with a snag or with the flesh of the fish as the coil and hook are retrieved. In addition while the angle of the coil will readily cause the hook to slide to the portion of the coil most adjacent the shaft, in effecting the disengagement of the hook from the fish adequate tension is applied to the line to cause the hook to remain in position on the coil so that the hook can be pushed or pulled relative to the body of the fish or to the snag. On the application of a pushing force the retrieval device does not need to be displaced too far inwardly into the body of the fish or towards the sang during the disengagement step.

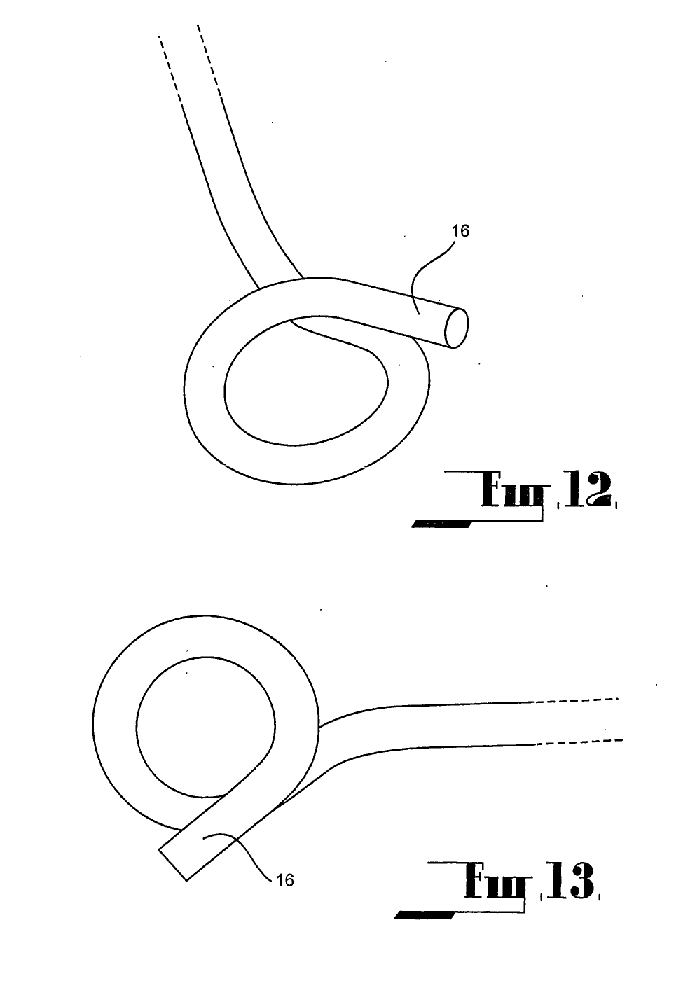

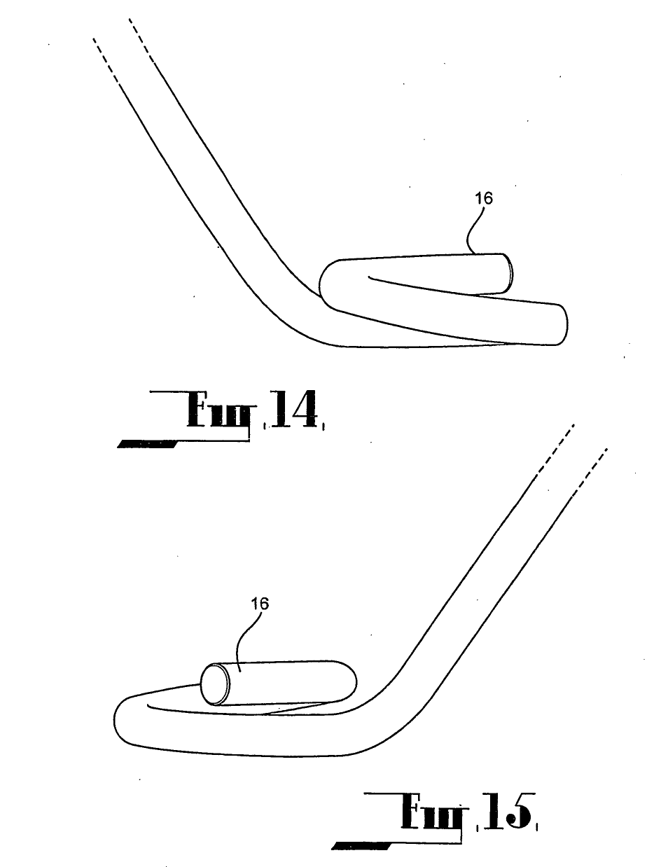

The fourth embodiment as shown at FIGS. 12 to 15 is a lure retrieval device and is a variation of the third embodiment except that the free end portion 16 of the coil is located adjacent the shaft rather than being remote as in the case of the first embodiment and the coil has an extent of approximately 1¼ turns. In addition the free end portion 16 of the coil extends substantially tangentially from the coil and is spaced slightly from the previous turn.

The fourth embodiment provides the advantages over the first embodiment in that:
it is more easily attached to the line;
once the coil is engaged with the line there is a reduced likelihood of the line becoming disengaged from the coil during retrieval; and
the configuration of the coil provides that on manipulation of the coil the free end portion 16 and the remainder of the coil is readily accessible to the line and the line is more easily engaged in the slot and within the coil when the retriever is prodded around feeling for the submerged line. Once the line is encountered by any part of the shaft of the retriever, the operator can sense the line and with an upward movement of the retriever, the line will slide into the slot and engage with the coil.

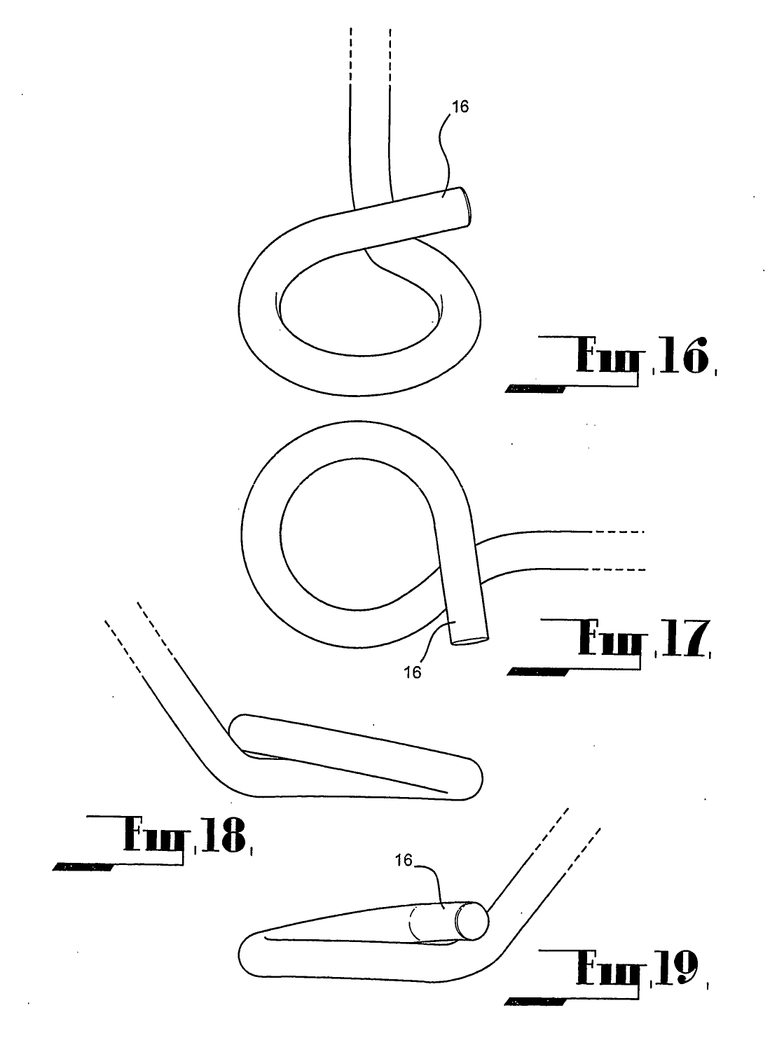

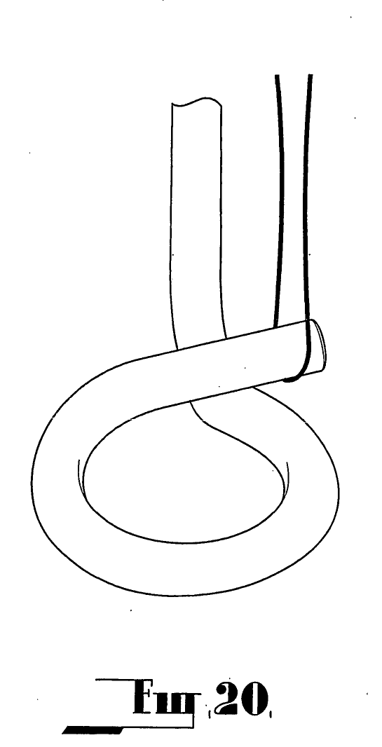

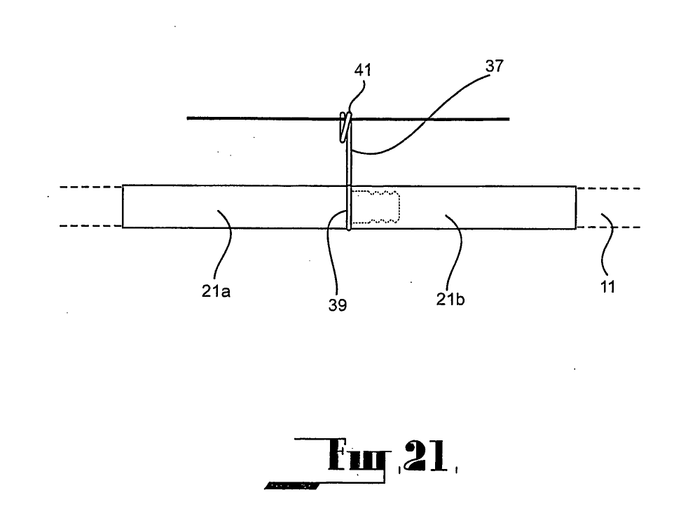

The fifth embodiment which is shown at FIG. 16 to 20 is a variation of the fourth embodiment with the exception the coil comprises a little more that a single revolution and the free end portion 16 of the coil at the point of overlying the previous turn is directed substantially tangentially to the coil. The design of the coil of the fifth embodiment is intended to enable the line to freely disengage form the coil after a floating lure has been freed. It is intended that once the lure has been freed it will float upwards and in so doing will draw the line through the slot to cause disengagement as illustrated at FIG. 20.

The sixth embodiment of the invention relates to a “stand-off coil” 37 which can be used with any of the previous embodiments which have comprised a retriever. The stand-off coil 37 is intended to be located at one or more intermediate positions along the length of the shaft depending upon the length of the shaft and provide support for the line being supported by the coil and for reasons which will be described to enable the line to reinforce the shaft when in use. The stand-off coil can be a moulded item formed of a suitable plastics material having sufficient strength and/or resilience or from a length of suitable metal rod and is configured to provide a circular ring shaped base 39 which is dimensioned to be received around the externally threaded portion 35 of the second coupling member 21b and thus to be clampingly received between the coupling members 21a and 21b at an intermediate position along the shaft. The free end of the stand off coil is formed as a coil 41 of a similar form to the coils which comprise the engagement means of the previous embodiments to enable the user to readily engage and disengage the line with the stand-off coil. In use where the retriever is being used in fast flowing water there is a tendency for the shaft to bend under the influence of the water flow and this can create a difficulty for the user in locating a snagged lure or once located in applying sufficient pressure to dislodge the lure . In use the line is held tight while the engagement means is caused to pass down the length of the line. The presence of the stand-off coil serves to provide support between the taut line and the shaft at one or more positions along the shaft to prevent the shaft from bending.

It is a feature of the retriever according to tat least some of the above embodiments that because the coil is offset to the axis of the shaft keeps the line clear of retriever which reduces the amount of friction wear on line and provides a better “better feel” for the user. In addition because the coil is angled to the axis of the shaft the face of the coil is presented at the best angle to the lure to effect a retrieve and tend to keep the retriever in a single orientation. This tendency of the retriever to remain in a single orientation also serves to prevent the user inadvertently rotating the retriever preventing the threaded couplings from unthreading. In the embodiments where the base of coil outermost this results in a reduced chance of the line becoming detached from coil during a retrieval action, automatic engagement of line into the coil with a submerged unseen line and a very reduced possibility of the line caught between revolutions of the coil which would impede the feel of the line in the coil. Furthermore with the end of coil extending past circumference of coil this serves to prevent the line becoming unattached during a retrieval action. In utilisation of each of the embodiments rotation of the shaft through a little more that a single rotation about its central axis will enable an easy line attachment between the coil and the line. The extendible nature of the shaft extension design allows for unlimited extension of length of retriever. In the case of the fifth embodiment just over one revolution will enable release of a retrieved lure/furthermore the use of the stand-off coils of the sixth embodiment can extend the current and depth capacity of the retrieval device. It is a further characteristic of each embodiment that the use of solid fibreglass shafts does not permit the entry of water into the shaft, enables the shaft to flex without does not resulting in failure of the shaft or the shaft being permanently bent and enables the shaft to have a reduced diameter to result In reduced water drag in strong current conditions facilitates a more effective prodding action and ease of use by the operator.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiments described above. In particular the invention need not be limited to particular application described above in relation to the embodiments but can be utilised with any flexible elongate member or line to retrieve an object or manipulate a free end of the line. In addition the engagement member of the invention and which takes the form of a coil does not need to have the particular configuration as described in relation to each of the embodiments but can take the form of the mirror image of each of the embodiments and can comprise a left handed or a right handed coil.

1. A retrieval aid intended for use with a flexible line having an object located at the end of the line, the retrieval aid comprising a shaft having a line engagement member mounted at one end and the other end is adapted to in use be supported by the user for manipulation by the user, said engagement member being readily engagable with the line whereby when engaged with the line the engagement member surrounds the line and is capable of movement along the line wherein the engagement member is formed as a single substantially circular coil, wherein the coil comprises more than one turn but less than to turns, each turn being of the same diameter and wherein the coil extends beyond the end of the shaft, wherein the coil is inclined at an acute angle to an axis which extends from the end of the shaft and is coaxial with the central axis of the shaft such that the coil is angularly offset to one side of the central axis of the shaft.

2. A retrieval aid intended for use with a flexible line having an object located at the end of the line, the retrieval aid comprising a shaft having a line engagement member mounted at one end and the other end is adapted to in uses be supported by the user for manipulation by the user, said engagement member being readily engagable with the line whereby when engaged with the line the engagement member surrounds the line and is capable of movement along the line wherein the engagement member is formed as a substantially circular coil comprising more than one turn but less than two turns each turn being of substantially the same diameter with the turns overlying each other, with one end being fixed to the shaft and the other end being the free end and wherein the coil extends beyond the end of the shaft, the portion of the coil proximate the free end extending outwardly from the perimeter of the underlying turn and wherein the coil is inclined at an acute angle to an axis which extends from the end of the shaft and is coaxil with the central axis of the shaft such that the coil is angularly offset to one side off the central axis of the shaft.

3. A retrieval aid as claimed at claim 1 or 2 wherein the engagement member is supported from the one end of the shaft to extend to one side of the shaft.

4. A retrieval aid as claimed at claim 1 or 2 wherein the adjacent portions of the turns of the coil are spaced from each other.

5. A retrieval aid as claimed at claim 1 or 2 or 4 wherein the coil comprises a approximately 1¼ turns.

6. A retrieval aid as claimed at claim at any one of the preceding claims wherein the base of the coil to which the shaft is attached is axially outermost relative to the shaft and the remainder of the coil.

7. A retrieval aid as claimed at any one of claims 1 to 5 wherein the base of the coil to which the shaft is attached is axially innermost relative to the shaft and the remainder of the coil.

8. A retrieval aid as claimed at any one of the proceding claims wherein the shaft is extendable.

9. A retrieval aid as claimed at claim 8 wherein the shaft comprises a plurality of lengths which can be interconnected into an end to end relationship.

10. A retrieval aid as claimed at claim 9 wherein each end of each length is provided with a threaded fitting which can be threadably engaged with a complementary fitting of another length to enable said ends to end interconnection.

11. A retrieval aid as claimed at any one of the preceding claims wherein the shaft is resiliently flexible.

12. A retrieval aid as claimed at claim 11 wherein the shaft is formed of a fibre reinforced plastics material.

13. A retrieval aid as claimed at any one of the preceding claims wherein the shaft supports a retention member which is slidable along the shaft and a cord is fixed at one end to the retention member, the shaft being formed to prevent disengagement of the retention member from either end of the shaft.

14. A retrieval aid as claimed at any one of the proceding claims wherein said coil has an internal diameter less than the width of object supported by the line.

15. A retrieval aid as claimed at any one of claims 1 to 13 wherein said coil has an internal diameter greater than the width of object supported by the line.

16. A retrieval as claimed at any one of the preceding claims wherein the line comprises a fishing line and the object comprises a fish hook and/or lure.

17. A retrieval aid as claimed at any one of the proceding claims wherein the device can be used to retrieve a fish hook from the body of a fish.

18. A retrieval aid as claimed at any one of the preceding claims wherein the shaft supports at least one stand-off coil intermediate the length of the shaft, said stand-off coil comprises more than one turn wherein the central axis of the coil is substantially parallel to the shaft.

19. A retrieval aid as claimed at claim 18 wherein the stand-off coil is removably supported from the shaft.

20. A retrieval aid as claimed at claim 18 as dependant from claim 9 or 10 wherein the stand-off coil is adapted to be clampingly received between the ends of a pair of interconnected lengths.

21. A retrieval aid as claimed at any one of the preceding claims wherein the acute angle is between 10 and 60 degrees.

22. A retrieval aid as claimed at any one of claims 1 and claims 4 to 21 as dependant from claim 1 wherein the coil has a length greater than one revolution and the free end of the coil extends outwardly from the outer perimeter of the coil.

23. A retrieval aid as claimed at claim 22 wherein the central axis of the free end subtends an angle of less than 90° to the central axis of the shaft.

24. A retrieval aid as claimed at any one of the preceding claims wherein the coil is removable form the one end.

25. A retrieval aid as claimed at any one of the preceding claims wherein a handle is mounted to the other end.

26. A retrieval aid intended for use with a flexible line having an object located at the end of the line, the retrieval aid comprising an engagement member adapted to be mounted to one end of a shaft, the other end of the shaft being adapted to in use be supported by the user for manipulation by the user, said engagement member being readily engagable with the line whereby when engaged with the line the engagement member surrounds the line and is capable of movement along the line wherein the engagement member is formed as a single substantially circular coil, wherein the coil comprises more than one turn but less than two turns, each turn being of the same diameter and wherein the coil will extend beyond the end of the shaft and will be is inclined at an acute angle to an axis which extends from the end of the shaft and is coaxil with the central axis of the shaft such that the coil is angularly offset to one side of the central axis of the shaft.

27. A retrieval aid substantially as herein described with reference to the accompanying drawings.
